(19) United States
(12) Patent Application Publication
(10) Pub. No.: US 2026/0299253 A1
(43) Pub. Date: Oct. 1, 2026

(54) CAMERA MODULE

(71) Applicant: SEIKOH GIKEN Co., Ltd., Matsudo-shi (JP)

(72) Inventor: Tomomi HIRAO, Matsudo-shi (JP)

(21) Appl. No.: 19/574,432

(22) Filed: Mar. 23, 2026

(30) Foreign Application Priority Data
Mar. 28, 2025 (JP) 2025-055030

(51) Int. Cl. G02B 9/10; G02B 13/00

(52) U.S. Cl. CPC G02B 9/10; G02B 13/003

(57) ABSTRACT

A camera module in which a first lens, an aperture stop, a second lens, a filter, a cover glass and an image sensor are arranged in order from an object side toward an image side, the camera module is configured to satisfy the following conditions (1) through (3) and has a field-of-view angle of 90 degrees or more: (1) 0.1<|r2/r1|<0.4, (2) 0.05<|r4/r3|<0.3, (3) 1.5<d2/d1<3.0, wherein r1: radius of curvature of object-side surface of the first lens, r2: radius of curvature of image-side surface of the first lens, r3: radius of curvature of object-side surface of the second lens, r4: radius of curvature of image-side surface of the second lens, d1: distance on optical axis from object-side surface of first lens to aperture stop, d2: distance on optical axis from aperture stop to photosensitive surface of image sensor.

### CROSS-REFERENCE TO RELATED APPLICATIONS

This patent specification is based on Japanese patent application, No. 2025-055030 filed on Mar. 28, 2025 in the Japan Patent Office, the entire contents of which are incorporated by reference herein.

### TECHNICAL FIELD

The present invention relates to a lens unit that achieves both miniaturization and wide-angle capability while maintaining optical performance, and a camera module including an image sensor.

### BACKGROUND OF THE INVENTION

A device for capturing external image information is equipped with a camera module including a lens unit having a lens for condensing light and an image sensor for converting the light into an electrical signal to acquire image data based on externally incident light.

In recent years, the camera module is widely used not only for capturing images for human viewing, as in smartphones and digital cameras, but also for sensing applications that extract various digital information from the images.

For example, a plurality of camera modules for sensing are mounted in an eye-tracking system that captures gaze direction, which is installed in a VR goggle, and in a ranging system mounted on a robot that moves automatically in a specific space.

Since the above described camera modules are mounted in large numbers on a single device or apparatus, further miniaturization is demanded due to design aesthetics and installation space constraints.

In addition, since a large number of camera modules are used in a single device or apparatus, less expensive image sensors and lens units are demanded.

The image sensor used in the camera modules for sensing employs a shutter system that prevents image distortion caused by moving objects during still image capture. However, it is difficult to reduce the per-pixel size in the image sensor employing the shutter system.

However, in recent years, with the advancement of semiconductor manufacturing processes, the per-pixel size is decreasing, and miniaturization of the image sensor for sensing is achieved.

Since miniaturization of the image sensor is achieved, the number of chips obtained per wafer is increased and the cost of the image sensor is decreasing.

On the other hand, cost reduction of the lens unit can be achieved by replacing with resin lenses and by applying aspherical shapes to the lens surface to reduce the number of lenses.

In addition to cost reduction and miniaturization, a wide-angle lens unit having a large field-of-view angle is increasingly demanded for the lens unit in order to increase the information obtainable from a single camera module.

Generally, when the field-of-view angle is increased, the radial size of the lens unit increases, and it is said that it is difficult to achieve both miniaturization and wide-angle capability.

To overcome the above described challenges, the technologies for achieving a compact lens unit with a wide field-of-view angle using fewer lenses are disclosed in the following Patent Documents 1 to 3.

### PRIOR ART DOCUMENT

### Patent Documents

[Patent Document 1] Japanese Patent Application Publication No. 2008-83735
[Patent Document 2] Japanese Patent Application Publication No. 2006-337402
[Patent Document 3] Japanese Patent Application Publication No. H9-159912

### SUMMARY OF THE INVENTION

Generally, in order to achieve a lens unit having a wide field-of-view angle, a retrofocus-type configuration in which a front group has negative refractive power and a rear group has positive refractive power is often adopted.

In a case where a wide-angle lens is to be achieved with a minimum configuration of two lenses, the configuration is such that a first lens has negative refractive power and a second lens has positive refractive power.

An aperture stop that determines the brightness and field-of-view angle of the lens unit is arranged at either one of a position between the first lens and the second lens or a position between the second lens and the image sensor.

The above described Patent Document 1 discloses a two-element wide-angle lens unit in which the first lens has negative refractive power, the second lens has positive refractive power, and the aperture stop is arranged between the second lens and the image sensor.

In the technology disclosed in the above prior document, since the object-side surface of the first lens is a concave surface, it is possible to increase the radius of curvature of the concave surface of the image-side surface, thereby reducing the manufacturing difficulty of the first lens, which is a challenge in wide-angle lenses.

In addition, when the distance between the first lens and the second lens is optimally set, a sufficient back focus for inserting a filter component between the second lens and the image sensor can be secured.

However, since the aperture stop is arranged between the second lens and the image sensor, the total length of the lens unit increases. In addition, the effective diameter of the first lens becomes larger than the diagonal size of the image sensor. Thus, the miniaturization is insufficient.

The above described Patent Document 2 discloses a two-element wide-angle lens unit in which the first lens has negative refractive power, the second lens has positive refractive power, the aperture stop is arranged between the second lens and the image sensor, and the object-side surface of the first lens has a strongly concave shape near the optical axis and becomes convex after passing through an inflection point toward the lens periphery.

In the technology disclosed in the above prior document, since the object-side surface of the first lens strongly is a concave surface, it is possible to make the radius of curvature of the image-side surface even larger than that of the wide-angle lens disclosed in Patent Document 1, thereby reducing the manufacturing difficulty of the first lens and also obtaining the effect of suppressing performance degradation caused by decentering error of the lens surface.

In addition, while the aperture stop is arranged between the second lens and the image sensor, the total length of the lens unit can be made shorter than that of Patent Document 1 by optimally setting the distance between the first lens and the second lens.

However, the problem that the effective diameter of the first lens becomes larger than the diagonal size of the image sensor is not resolved, and the miniaturization is insufficient.

The above described Patent Document 3 discloses a two-element wide-angle lens unit in which the first lens has negative refractive power, the second lens has positive refractive power, and the aperture stop is arranged between the first lens and the second lens.

In the technology disclosed in the above prior document, since the object-side surface of the first lens is a concave surface, it is possible to increase the concave radius of curvature of the image-side surface, thereby reducing the manufacturing difficulty of the first lens, which is a challenge in wide-angle lenses.

In addition, the first lens is formed in a biconcave shape to shift the rear principal point of the first lens toward the object side, and the second lens is formed in a biconvex shape to make the radius of curvature of the image-side surface smaller than that of the object-side surface and to shift the front principal point of the second lens toward the image side. Since the principal points of the two lenses are separated, a reduction in the total length of the lens unit is successfully achieved.

However, in the above prior document, since the curvature of the object-side surface of the first lens becomes large, there is a limit to increasing the radius of curvature of the image-side surface. While this is not a problem for a lens having a field-of-view angle of 90 degrees or less as shown in the embodiments, the problem that manufacturing of the first lens becomes difficult when the field-of-view angle is further increased is not resolved.

In addition, since the object-side surface of the first lens has a shape close to a flat surface, when the field-of-view angle is increased beyond that of the embodiments, the effective diameter of the object-side surface of the first lens becomes large, which is not suitable for miniaturization.

Accordingly, in view of the above described challenges, the present invention provides a camera module using a lens unit that achieves both miniaturization and wide-angle capability while maintaining optical performance, with a minimal configuration of two inexpensive resin lenses.

In a camera module according to the present invention, a first lens L1 having negative refractive power; an aperture stop AP configured to determine a brightness and a field-of-view angle; a second lens L2 having positive refractive power; a filter OF configured to reflect or absorb a specific light; a cover glass CG configured to protect the image sensor; and an image sensor S configured to convert the light into an electrical signal arranged in this order from an object side. An object-side surface L1R1 of the first lens L1 has a rotationally symmetric aspherical shape having an inflection point such that a region near an optical axis has a concave surface facing the object side and a peripheral portion has a convex surface facing the object side. An image-side surface L1R2 of the first lens L1 has a rotationally symmetric aspherical shape having a concave surface facing the image side. An object-side surface L2R1 of the second lens L2 has a rotationally symmetric aspherical shape having a convex surface facing the object side. An image-side surface L2R2 of the second lens L2 has a rotationally symmetric aspherical shape having a convex surface facing the image side. The first lens L1 and the second lens L2 are formed of resin. An effective diameter of the first lens L1 and the second lens L2 through which a light ray passes is the largest on the object-side surface L1R1 of the first lens L1. The effective diameter through which the light ray passes on the object-side surface L1R1 of the first lens L1 is smaller than a diagonal length Y of a light-receiving portion of the image sensor S. The camera module is configured to satisfy the following conditions (1) through (3) and has the field-of-view angle of 90 degrees or more.

0.1<|r2/r1|<0.4 (1)

0.05<|r4/r3|<0.3 (2)

1.5<d2/d1<3.0 (3)
r1: a radius of curvature of the object-side surface L1R1 of the first lens L1,
r2: a radius of curvature of the image-side surface L1R2 of the first lens L1,
r3: a radius of curvature of the object-side surface L2R1 of the second lens L2,
r4: a radius of curvature of the image-side surface L2R2 of the second lens L2,
d1: a distance on the optical axis from the object-side surface L1R1 of the first lens L1 to the aperture stop AP, and
d2: a distance on the optical axis from the aperture stop AP to a photosensitive surface S1 of the image sensor S.

As described above, according to the present invention, it is possible to provide a lens unit that achieves both miniaturization and wide-angle capability while maintaining optical performance with a minimal configuration of two inexpensive resin lenses, and a camera module using an image sensor.

### BRIEF DESCRIPTION OF DRAWINGS

FIG. 1 is an optical arrangement diagram of a camera module.

FIG. 2 is an explanatory diagram of each lens surface.

FIG. 3 is an explanatory diagram of an optical axis and an origin.

FIG. 4 is an explanatory diagram of a maximum field-of-view angle ray and a principal ray.

FIG. 5 is an explanatory diagram of a principal ray incident angle.

FIG. 6 is an explanatory diagram of an inflection point and an effective diameter of a first lens.

FIGS. 7A and 7B are peripheral light intensity graphs.

FIG. 8 is a cross-sectional view of a small-sized camera module.

FIG. 9 is a ray diagram of Example 1.

FIG. 10 is aberration diagrams of Example 1.

FIG. 11 is a peripheral light intensity graph of Example 1.

FIG. 12 is a ray diagram of Example 2.

FIG. 13 is aberration diagrams of Example 2.

FIG. 14 is a peripheral light intensity graph of Example 2.

FIG. 15 is a ray diagram of Example 3.

FIG. 16 is aberration diagrams of Example 3.

FIG. 17 is a peripheral light intensity graph of Example 3.

### DETAILED DESCRIPTION OF THE INVENTION

Hereinafter, the embodiments of the present invention will be explained in detail with reference to the drawings. However, the present invention can be implemented in many different forms, and is not limited to the specific embodiments and specific examples described below.

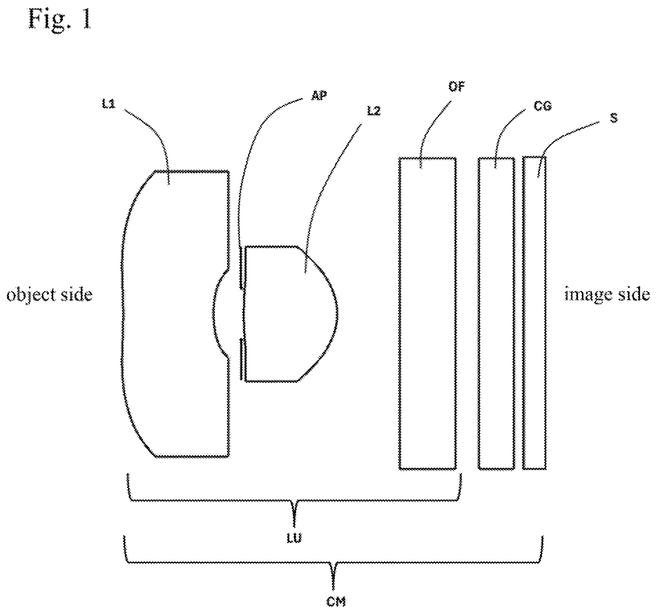

FIG. 1 is a diagram showing an optical arrangement of a camera module CM according to the present embodiment. As shown in the figure, a first lens L1, an aperture stop AP configured to determine a brightness and a field-of-view angle, a second lens L2, a filter OF configured to reflect or absorb a specific light, a cover glass CG configured to protect an image sensor, and an image sensor S configured to convert a light into an electrical signal are arranged in this order from the object side.

First, the camera module CM of the present application includes a lens unit LU configured of the first lens L1 having negative refractive power, the second lens L2 having positive refractive power, the aperture stop AP and the filter OF as described above. The lens unit LU has a function of refracting and converging incident light, and the converged light strikes the image sensor S protected by the cover glass CG and is output as a signal for forming an image.

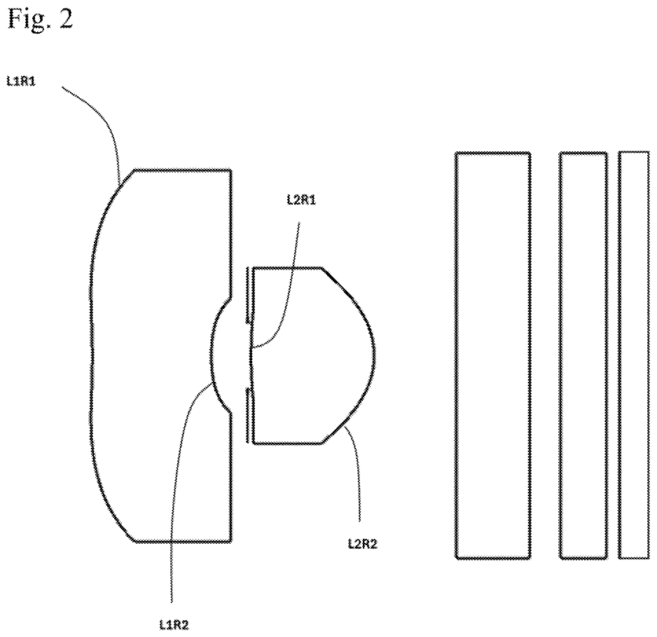

As shown in FIG. 2, the object-side surface L1R1 of the first lens L1 has a rotationally symmetric aspherical shape having an inflection point such that a region near the optical axis has a concave surface facing the object side and a peripheral portion away from the optical axis has a convex surface facing the object side. The image-side surface L1R2 of the first lens L1 has a rotationally symmetric aspherical shape having a concave surface facing the image side. The object-side surface L2R1 of the second lens L2 has a rotationally symmetric aspherical shape having a convex surface. The image-side surface L2R2 of the second lens L2 has a rotationally symmetric aspherical shape having a convex surface. The lens unit LU is configured to satisfy the following conditions (1) and (2) and has a field-of-view angle of 90 degrees or more. The object-side surface L1R1 of the first lens L1 has a concave surface and a convex surface facing the object side. The region on the optical axis side of the inflection point between the concave surface and the convex surface is defined as the region near the optical axis, and the region outside the inflection point is defined as the peripheral portion.

$$0.1 < \vert r 2 / r 1 \vert < 0.4 \qquad ( 1 )$$

$$0.05 < \vert r 4 / r 3 \vert < 0.3 \qquad ( 2 )$$

r1: a radius of curvature of the object-side surface L1R1 of the first lens L1
r2: a radius of curvature of the image-side surface L1R2 of the first lens L1
r3: a radius of curvature of the object-side surface L2R1 of the second lens L2
r4: a radius of curvature of the image-side surface L2R2 of the second lens L2

The negative refractive power is imparted to the first lens and the positive refractive power is imparted to the second lens to adopt a retrofocus-type configuration advantageous for achieving a wide angle of the lens unit LU. Additionally, since the aperture stop AP is placed between the first lens and the second lens, it is possible to obtain the effect of shortening the total length of the lens unit LU, which is a challenge in the retrofocus type. Therefore, the lens unit LU having a short total length and a large field-of-view angle can be achieved.

Furthermore, the first lens and the second lens are formed of resin and both surfaces of the object-side and the image-side of the lenses are configured to be aspherical. Thus, a compact, high-performance and inexpensive lens unit LU can be achieved while maintaining a wide field-of-view angle with a small number of only two lenses. Any transparent resin material can be used as the lens material as long as the resin material has a transmittance of 80% or more at the wavelength to be used. As the resin material, an energy-curable resin, which cures upon receiving external energy such as heat, light or electron beams, and a thermoplastic resin, which melts and flows when heated and solidifies when cooled, are known. As the energy curable resin, a thermosetting epoxy resin, which cures by heat, and a UV curable acrylic resin, which cures under UV light, are well known. As the thermoplastic resin, a polycarbonate resin, a cyclic olefin resin, a polyetherimide resin and a polysulfone resin are known. In addition, the resin material may contain inorganic fine particles such as silica or zirconia for improving hardness or adjusting the refractive index. Even when the inorganic fine particles are contained, the material may be regarded as a resin material as long as the content of the inorganic fine particles is 50% or less by volume. Each resin is selected and used as appropriate according to the characteristics required for each product, such as hardness, transparency, toughness, impact resistance, weather resistance and heat resistance.

Regarding the first lens L1, the object-side surface L1R1 has an inflection point such that a region near an optical axis has a concave surface facing the object side and a peripheral portion has a convex surface facing the object side, the image-side surface L1R2 has a concave surface facing the image side, and the condition (1) is satisfied. Thus, the first lens L1 functions as a biconcave lens up to the inflection point of the object-side surface L1R1 and functions as a negative meniscus lens beyond the inflection point.

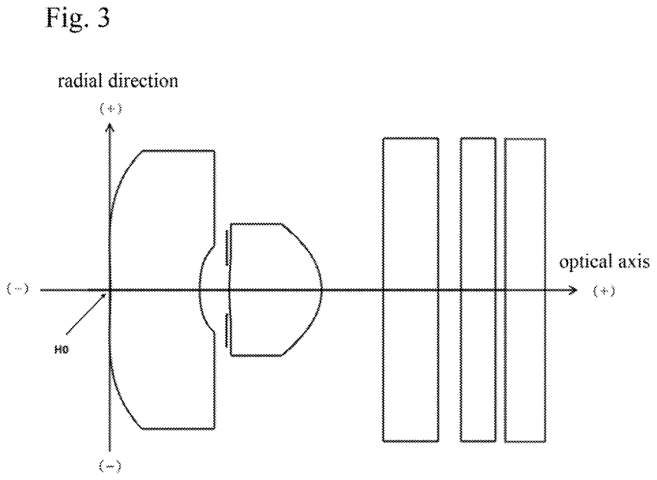

Here, as shown in FIG. 3, the optical axis is a virtual axis defined by connecting the centers of the first lens L1, the second lens L2 and the image sensor S with the direction from the object side toward the image side defined as the positive direction. Note that the origin of the optical axis is defined as the point where the center of the first lens L1 and the optical axis intersect.

Within the range of the condition (1), the radius of curvature of the object-side surface L1R1 of the first lens L1 can be made small and the radius of curvature of the image-side surface L1R2 can be made relatively large while maintaining a field-of-view angle of 90 degrees or more, thereby improving the workability of the image-side surface L1R2, which is a challenge in wide-angle lenses. When the upper limit of the condition (1) is exceeded, the radius of curvature of the object-side surface L1R1 becomes large, and the radius of curvature of the image-side surface L1R2 becomes too small, resulting in a shape that is difficult to process. When the lower limit of the condition (1) is not reached, the radius of curvature of the image-side surface L1R2 becomes large as the radius of curvature of the object-side surface L1R1 becomes small, but the power of the object-side surface L1R1 becomes too strong, making it difficult to increase the field-of-view angle while maintaining performance.

Furthermore, when the condition (1) is satisfied, the principal point of the first lens L1 can be shifted toward the object side. When the condition (2) is satisfied, the principal point of the second lens L2 can be shifted toward the image side. Therefore, the distance between the principal point of the first lens and the principal point of the second lens increases, resolving the challenge of the retrofocus type in which the total length of the lens unit LU becomes long, and enabling shortening of the total lens length.

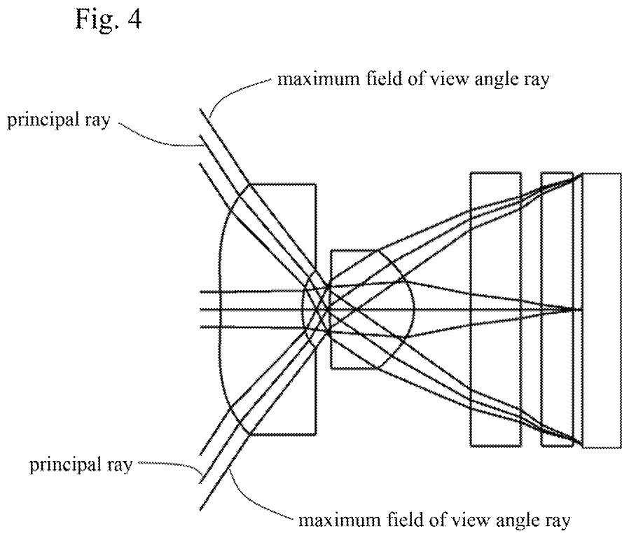

As shown in FIG. 4, the effective diameter of the first lens L1 and the second lens L2 through which a light ray passes is the largest on the object-side surface L1R1 of the first lens L1. The effective diameter through which the light ray passes on the object-side surface L1R1 of the first lens is smaller than the diagonal length Y of the light-receiving portion of the image sensor S. The following condition (3) is satisfied and the field-of-view angle is 90 degrees or more.

$$1.5 < d 2 / d 1 < 3. \qquad ( 3 )$$

d1: a distance on the optical axis from the object-side surface L1R1 of the first lens L1 to the aperture stop AP
d2: a distance on the optical axis from the aperture stop AP to the photosensitive surface S1 of the image sensor S

Generally, in a retrofocus-type wide-angle lens, it is known that the object-side surface L1R1 of the first lens L1 is the largest in the radial direction. Therefore, in order to reduce the radial size of the lens unit LU, it is necessary to minimize the effective diameter through which the maximum field-of-view angle ray passes on the object-side surface L1R1 of the first lens L1.

Here, the maximum field-of-view angle ray refers to a ray passing through the maximum field-of-view angle determined by the combination of the lens unit LU and the image sensor S as shown in FIG. 4. In addition, the effective diameter refers to the maximum diameter of each lens surface through which the maximum field-of-view angle ray passes. Note that the principal ray in FIG. 4 is a ray passing through the center of the aperture stop AP, and the field-of-view angle is determined by the principal ray.

In the present application, the aperture stop AP is placed between the first lens L1 and the second lens L2. Since the object-side surface L1R1 of the first lens L1 and the image-side surface L2R2 of the second lens L2 are arranged at positions on the optical axis that satisfy the condition (3) with respect to the aperture stop AP as the reference, it is possible to reduce the effective diameter of the object-side surface of the first lens L1 and prevent the angle of the light ray incident on the image sensor S from becoming excessive while maintaining a field-of-view angle of 90 degrees or more.

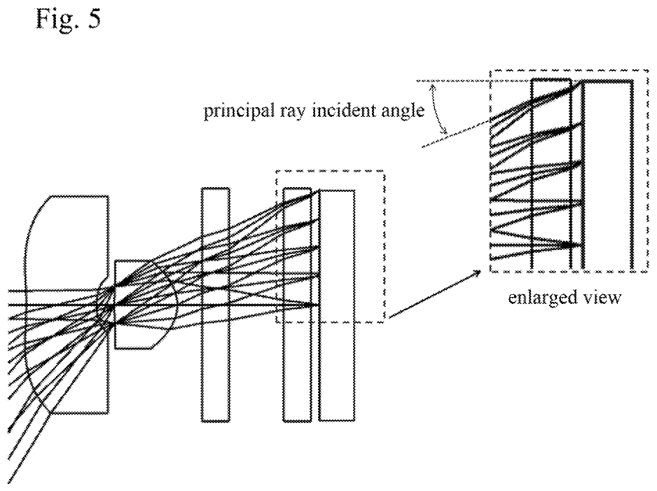

Although depending on the specifications of the image sensor to be used, the maximum incident angle of the principal ray onto the photosensitive portion of the image sensor, as shown in FIG. 5, is generally set in the range of 20 degrees to 40 degrees. If the above described range is exceeded, sufficient light does not reach the photosensitive portion, and the output image becomes dark. When the condition (3) is satisfied, a lens unit having a light ray incident angle suitable for the image sensor to be used can be achieved while achieving miniaturization.

It is desirable that the following conditions (4) and (5) are satisfied where the center position of L1R1 of the first lens L1 on the optical axis is defined as the origin H0, and the direction from the object side toward the image side is defined as the positive direction of the optical axis.

$$H 1 > 0 \qquad ( 4 )$$

$$0.3 < Dc / D 1 < 0 \text{.45} \qquad ( 5 )$$

H1: a position on the optical axis of the effective diameter of the object-side surface L1R1 of the first lens L1
Dc: a radial inflection point distance of the object-side surface L1R1 of the first lens L1
D1: a radial effective diameter distance of the object-side surface L1R1 of the first lens L1

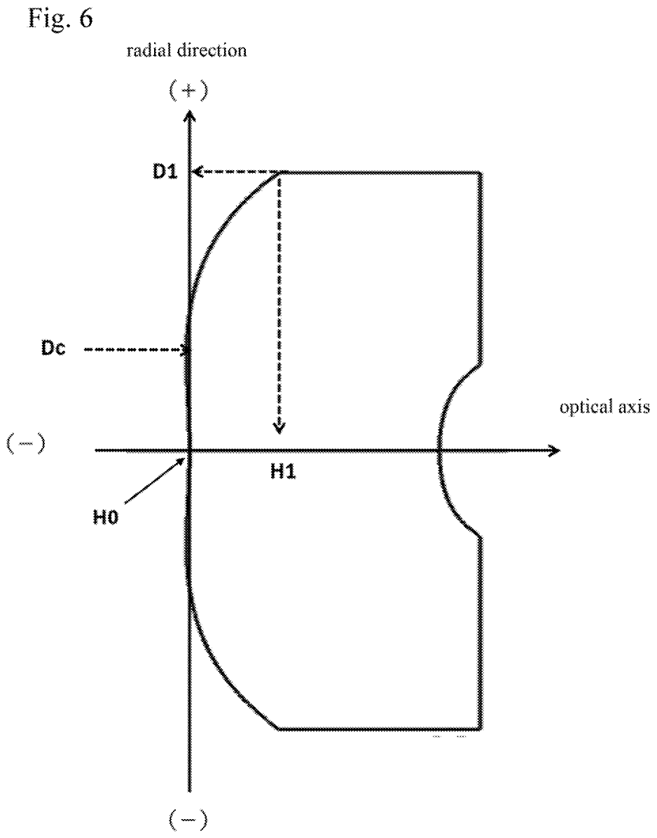

As shown in FIG. 6, satisfying the condition (4) means that when the position of the optical axis center of the object-side surface L1R1 of the first lens L1 is defined as zero, the position on the optical axis of the effective diameter of L1R1 is configured to be always in the image-side direction relative to the optical axis center position of L1R1. Furthermore, the condition (5) defines the position where the concave surface and the convex surface of the L1R1 shape switch.

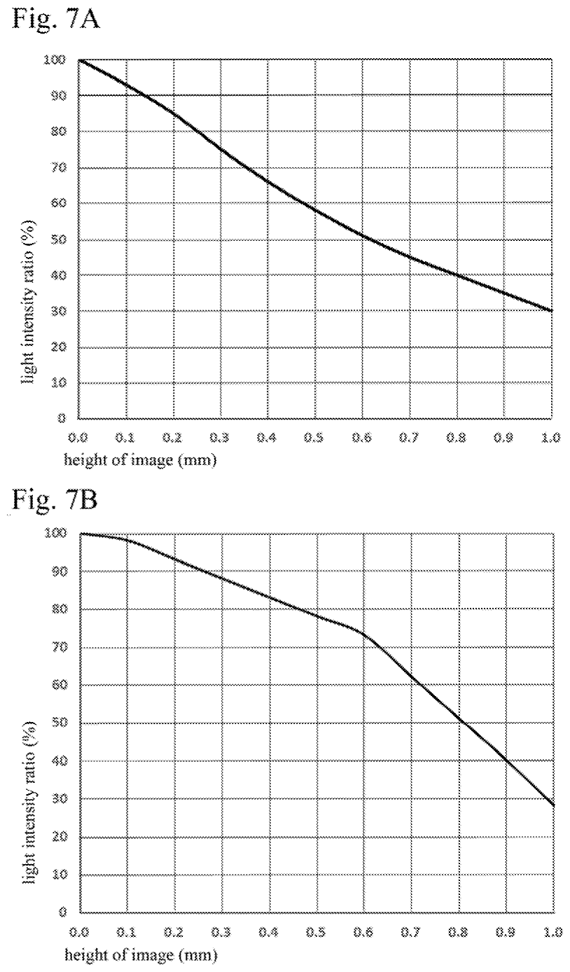

When the object-side surface L1R1 of the first lens L1 has the inflection point, care must be taken to avoid abrupt changes in peripheral light intensity. Since the light intensity can be adjusted by the settings of the image sensor, if the peripheral light intensity changes gradually as shown in the graph of FIG. 7A, the correction on the image sensor side is easy. However, if the light intensity changes abruptly partway through as shown in the graph of FIG. 7B, the correction on the image sensor side is difficult.

When the inflection point position of the object-side surface L1R1 is designed within the range of the condition (5), it becomes possible to switch from the concave surface to the convex surface in a narrow field-of-view angle region and to make the convex shape of the peripheral portion gradual. Therefore, abrupt changes in peripheral light intensity are suppressed, and degradation of the output image can be reduced.

Furthermore, it is desirable that the following condition (6) is satisfied.

$$0.55 < \vert f 2 / f 1 \vert < 0.85 \qquad ( 6 )$$

f1: a focal length of the first lens L1
f2: a focal length of the second lens L2

The condition (6) defines the ratio of the focal lengths of the first lens L1 and the second lens L2. If the focal length is small, the lens has a large power to bend light. When the lens has positive refractive power, the lens converges the light ray. When the lens has negative refractive power, the lens diverges the light.

In the present application, the first lens has negative refractive power and the second lens has positive refractive power. Since the diverging effect of the first lens and the converging effect of the second lens are combined, a retrofocus-type lens unit LU having a wide field-of-view angle is achieved.

The first lens L1 and the second lens L2 are combined as described above, and as a whole, form a lens unit LU having positive refractive power that converges an object image and forms the object image on the image sensor S.

In the combination of the first lens L1 and the second lens L2, when the lower limit of the condition (6) is not reached, it becomes difficult to increase the field-of-view angle. When the upper limit is exceeded, it becomes difficult to shorten the total lens length. When the first lens L1 and the second lens L2 are designed within the range of the condition (6), it is possible to widen the field-of-view angle while preventing the total lens length from becoming long.

It is desirable that the filter OF and the cover glass CG are bonded with a transparent adhesive A and satisfy the following conditions (7) and (8).

$$\vert NOF - NA \vert < 0.05 \qquad ( 7 )$$

$$\vert NCG - NA \vert < 0.05 \qquad ( 8 )$$

NOF: a refractive index of the filter OF
NA: a refractive index of the adhesive A
NCG: a refractive index of the cover glass CG

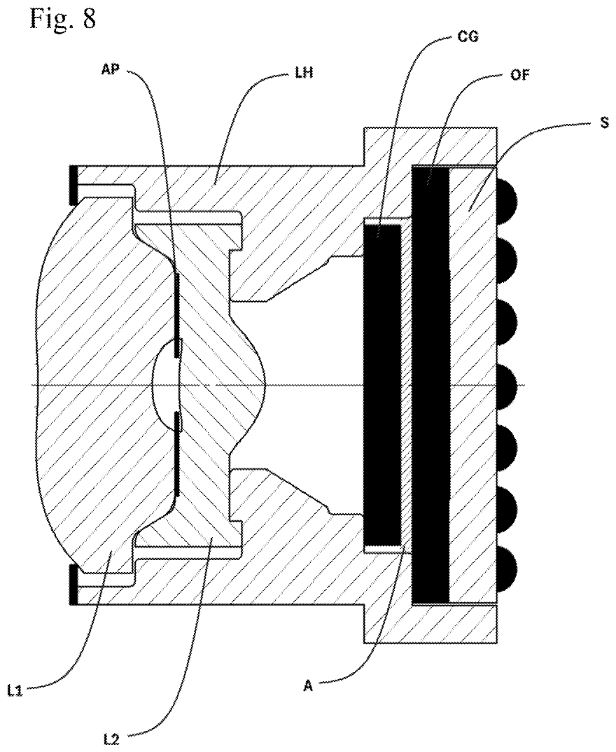

In order to achieve miniaturization, as shown in FIG. 8, the lens unit LU and the image sensor S are housed in a single light-shielding component LH. Although there are multiple methods for fixing each of the components of the lens unit LU, miniaturization of the camera module CM can be achieved by directly bonding to the filter OF via the cover glass CG that protects the image sensor S.

In order to reduce the size of the camera module CM, it is desirable to fix the lens unit LU and the image sensor S in a single light-shielding component LH. In this case, the size of the camera module CM depends on the size of the light-shielding component LH.

In the present application, since the largest component is the image sensor S, the size of the camera module CM is determined by how the image sensor S is fixed to the light-shielding component LH.

When trying to reduce the outer dimension size of the light-shielding component LH, it is difficult to form a structure for fixing the image sensor S in the light-shielding component LH. However, when the filter OF in the lens unit LU and the cover glass CG that protects the image sensor S are directly bonded and fixed via the adhesive A, the image sensor S can be fixed with sufficient fixing strength even when the size of the light-shielding component LH is small.

At this time, if the refractive index difference at the bonding surfaces is large, interface reflection becomes large, causing flare that degrades image quality and ghost defects in which spots of light occur due to stray light. When the refractive index difference is set to 0.05 or less for each bonding surface, the interface reflection becomes 0.1% or less. Therefore, when the conditions (7) and (8) are satisfied, the above-described flare and ghost defects do not occur.

### EXAMPLES

Here, the camera module referred to in the above embodiment will be specifically explained below.

The lens configuration and numerical examples of the examples according to the present invention will be explained. Note that the lens configuration is described in order from the object side to the image surface side in the following explanation.

In the lens surface data, the lens surface number is the number of the lens surface or the aperture stop counted from the object side, r is the radius of curvature of each lens surface, d is the interval between each lens surface, and nd is the refractive index at the d-line (wavelength 587.56 nm).

The notation “aperture stop” appended to the lens surface number indicates that the aperture stop AP is located at that position. For a flat surface or the aperture stop AP, ∞ (infinity) is entered as the radius of curvature.

The aspherical shape is expressed by the following equation (1). In the following equation (1), the displacement from the optical axis in the direction perpendicular to the optical axis is indicated by y, the displacement in the optical axis direction from the intersection of the aspherical surface and the optical axis (sag amount) is indicated by z, the radius of curvature of the reference sphere is indicated by r, and the conic coefficient is indicated by K. When the 3rd, 4th, 5th, 6th, 7th, 8th, 9th and 10th order aspherical coefficients are indicated by A3, A4, A5, A6, A7, A8, A9 and A10 respectively, the coordinates of the aspherical surface are expressed by the following equation.

$$z = \frac{( 1 / x ) {y}^{2}}{1 + \sqrt{1 - ( 1 + K ) {( y \vert r )}^{2}}} + A 3 {y}^{3} + A 4 {y}^{4} + A 5 {y}^{5} + A 6 {y}^{6} + A 7 {y}^{7} + A 8 {y}^{8} + A 9 {y}^{9} + A 10 {y}^{10} \qquad ( 1 )$$

Note that the units of the focal length f, the radius of curvature r, the lens surface interval d and other lengths described herein are millimeters (mm) unless otherwise specified.

### Example 1

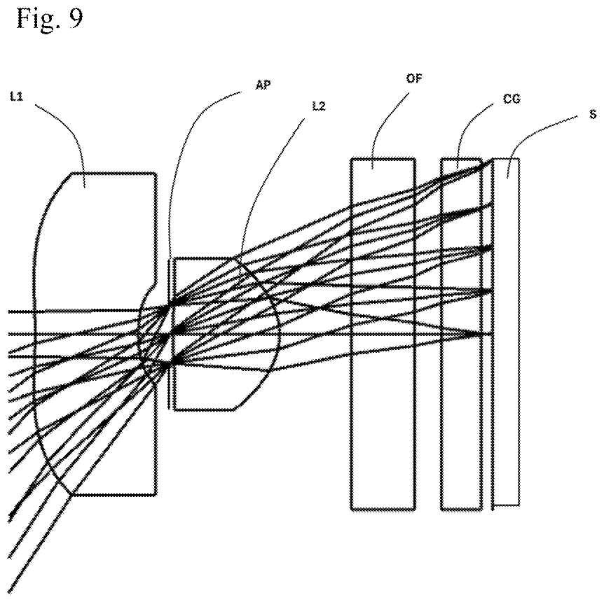

FIG. 9 is a ray diagram of Example 1 of the present invention.

In the optical system of Example 1, the first lens L1 having negative refractive power, the aperture stop AP configured to determine the brightness and the field-of-view angle, the second lens L2 having positive refractive power, the filter OF configured to reflect or absorb the specific light, the cover glass CG configured to protect the image sensor, and the image sensor S configured to convert the light into the electrical signal are arranged in this order from the object side.

The object-side surface L1R1 of the first lens L1 has a rotationally symmetric aspherical shape having an inflection point such that a region near the optical axis has a concave surface facing the object side and a peripheral portion has a convex surface facing the object side. The image-side surface L1R2 of the first lens L1 has a rotationally symmetric aspherical shape having a concave surface facing the image side. The object-side surface L2R1 of the second lens L2 has a rotationally symmetric aspherical shape having a convex surface facing the object side. The image-side surface L2R2 of the second lens L2 has a rotationally symmetric aspherical shape having a convex surface facing the image side. The first lens L1 and the second lens L2 are formed of resin.

The effective diameter through which the light ray of the first lens L1 and the second lens L2 passes is the largest on the object-side surface L1R1 of the first lens L1. The effective diameter through which the light ray passes on the object-side surface L1R1 of the first lens is smaller than the diagonal length Y of the light-receiving portion of the image sensor S.

The lens design data of the Example 1 is shown in Table 1. The definitions of the numerical values and the equations are as described above.

TABLE 1
[Surface data]

| | | | | effective |
|---|---|---|---|---|
| Surface No. | r | d | nd | diameter |
| 1 | −2.109 | 0.390 | 1.510 | 1.289 |
| 2 | 0.501 | 0.120 | — | 0.401 |
| 3 (aperture stop) | ∞ | 0.010 | — | — |
| 5 | 1.358 | 0.403 | 1.510 | 0.300 |
| 6 | −0.243 | 0.270 | — | 0.609 |
| 7 | ∞ | 0.240 | 1.523 | — |
| 8 | ∞ | 0.100 | — | — |
| 9 | ∞ | 0.150 | 1.517 | — |
| 10 | ∞ | 0.043 | — | — |
| Image surface | ∞ | | — | — |

[Aspherical surface data]

| | first surface | second surface | fifth surface | Sixth surface |
|---|---|---|---|---|
| K | −0.1 | −1.0 | 0.0 | −1.0 |
| A3 | 0 | 0 | 0 | 0 |
| A4 | 3.5729 | 18.976 | 3.5729 | 18.976 |
| A5 | 0 | 0 | 0 | 0 |
| A6 | −11.69 | 178.37 | 3.5729 | 18.976 |
| A7 | 0 | 0 | 0 | 0 |
| A8 | 27.203 | 0 | 27.203 | 0 |
| A9 | 0 | 0 | 0 | 0 |
| A10 | −24.05 | 0 | −24.05 | 0 |

wavelength: 850 nm
field-of-view angle: 113.2°
F-number: 2.65
sensor diagonal size: 1.294 mm

The calculation results of the conditions (1) through (8) for Examples 1 through 3 are shown in Table 2. The field-of-view angle is 90 degrees or more, and the conditions (1) through (6) are satisfied.

TABLE 2

| | lower | upper | | | |
|---|---|---|---|---|---|
| Condition | limit | limit | calculation value | | |
| No. | value | value | Example 1 | Example 2 | Example 3 |
| (1) | 0.10 | 0.40 | 0.238 | 0.130 | 0.378 |
| (2) | 0.05 | 0.30 | 0.179 | 0.245 | 0.210 |
| (3) | 1.50 | 3.00 | 2.384 | 2.316 | 2.532 |
| (4) | 0.00 | — | 0.139 | 0.144 | 0.121 |
| (5) | 0.30 | 0.45 | 0.336 | 0.306 | 0.433 |
| (6) | 0.55 | 0.85 | 0.584 | 0.759 | 0.597 |
| (7) | — | 0.05 | — | — | 0.0053 |
| (8) | — | 0.05 | — | — | 0.0012 |

By configuring as described above, field curvature and astigmatism are sufficiently corrected as shown in FIG. 10, and a gradual peripheral light intensity change that can be corrected by the image sensor is obtained as shown in FIG. 11. Therefore, a compact camera module with good image quality having a wide field-of-view angle can be achieved.

### Example 2

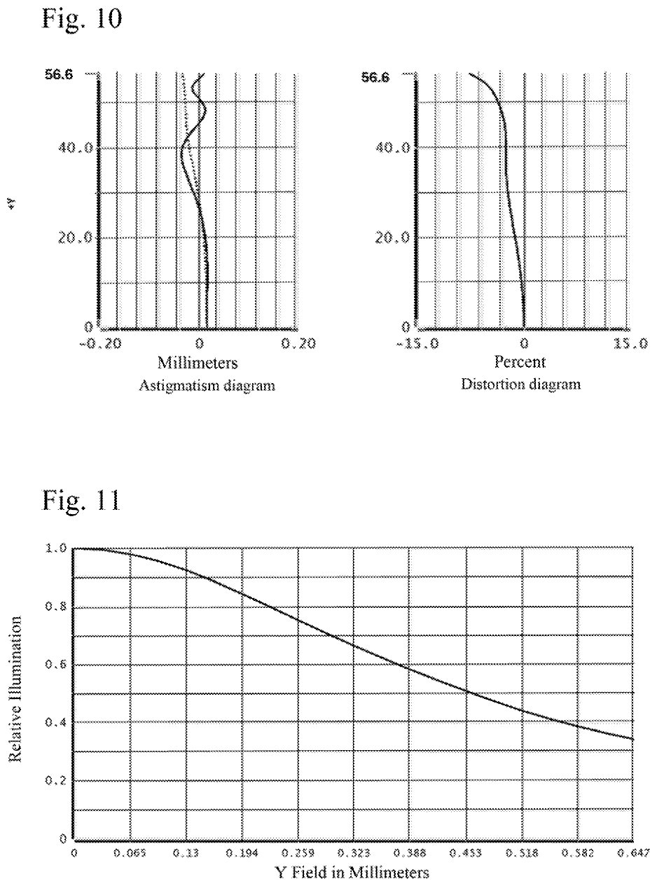

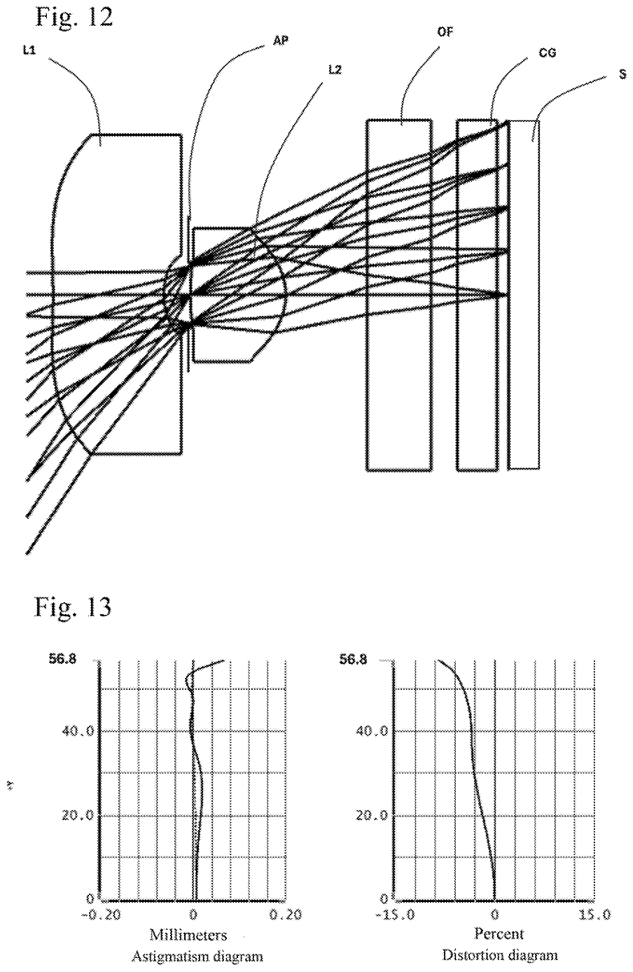

FIG. 12 is a ray diagram of Example 2 of the present invention.

The configuration of the optical system of Example 2 is the same as that of Example 1.

The lens design data of Example 2 is shown in Table 3.

TABLE 3
[Surface data]

| | | | | effective |
|---|---|---|---|---|
| Surface No. | r | d | nd | diameter |
| 1 | −2.458 | 0.419 | 1.510 | 1.186 |
| 2 | 0.320 | 0.100 | — | 0.297 |
| 3 (aperture stop) | ∞ | 0 | — | — |
| 5 | 0.932 | 0.361 | 1.510 | 0.258 |
| 6 | −0.228 | 0.308 | — | 0.496 |
| 7 | ∞ | 0.240 | 1.523 | — |
| 8 | ∞ | 0.100 | — | — |
| 9 | ∞ | 0.150 | 1.517 | — |
| 10 | ∞ | 0.043 | — | — |
| Image surface | ∞ | | — | — |

[Aspherical surface data]

| | first surface | second surface | fifth surface | Sixth surface |
|---|---|---|---|---|
| K | −0.1 | −1.0 | 0 | −1.0 |
| A3 | 0 | 0 | 0 | 0 |
| A4 | 3.669 | 60.184 | 6.838 | −5.873 |
| A5 | 0 | 0 | 0 | 0 |
| A6 | −12.7456 | −1994.73 | −27.4663 | 95.1459 |
| A7 | 0 | 0 | 0 | 0 |
| A8 | 30.5083 | 101,538 | 0 | −1,644.79 |
| A9 | 0 | 0 | 0 | 0 |
| A10 | −27.6684 | −210,552 | 0 | 26,341.50 |

wavelength: 850 nm
field-of-view angle: 113.5°
F-number: 2.65
sensor diagonal size: 1.294 mm

In this example, as shown in Table 3, the field-of-view angle is 90 degrees or more, and the conditions (1) through (6) are satisfied.

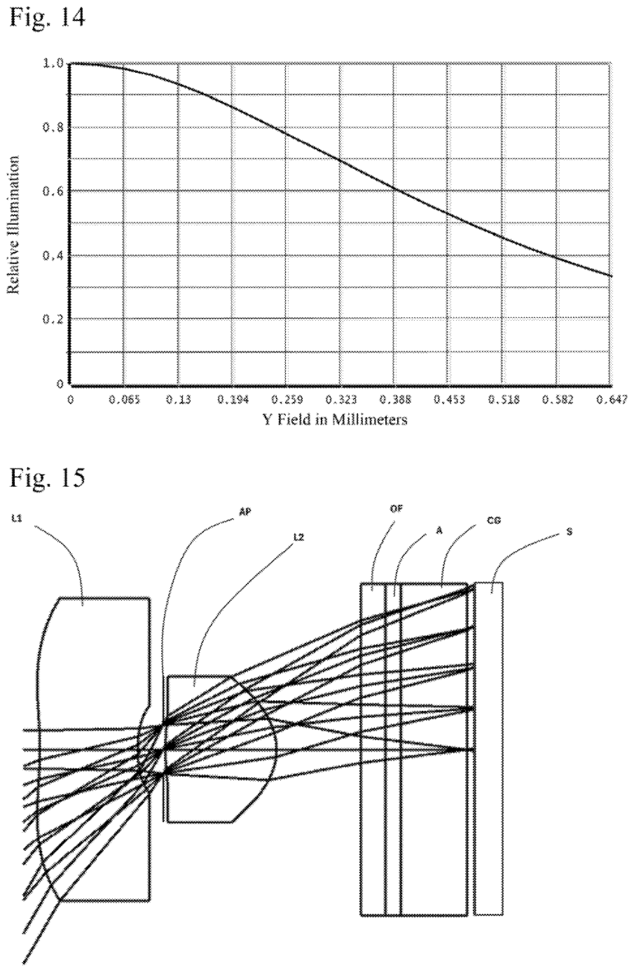

By configuring as described above, field curvature and astigmatism are sufficiently corrected as shown in FIG. 13, and a gradual peripheral light intensity change that can be corrected by the image sensor is obtained as shown in FIG. 14. Therefore, a compact camera module with good image quality having a wide field-of-view angle can be achieved.

### Example 3

FIG. 15 is a ray diagram of Example 3 of the present invention.

The differences in the configuration of the optical system of Example 3 from Example 1 will be described.

In Example 3, the filter OF and the cover glass CG are bonded and fixed with a transparent adhesive A.

The lens design data of this example is shown in Table 4.

TABLE 4
[Surface data]

| | | | | effective |
|---|---|---|---|---|
| Surface No. | r | d | nd | diameter |
| 1 | −2.458 | 0.590 | 1.510 | 1.820 |
| 2 | 0.802 | 0.152 | — | 0.528 |
| 3 (aperture stop) | ∞ | 0.016 | — | — |
| 5 | 1.664 | 0.670 | 1.510 | 0.399 |
| 6 | −0.350 | 0.508 | — | 0.878 |
| 7 | ∞ | 0.150 | 1.523 | — |
| 8 | ∞ | 0.090 | 1.518 | — |
| 9 | ∞ | 0.400 | 1.517 | — |
| 10 | ∞ | 0.045 | — | — |
| Image surface | ∞ | | — | — |

[Aspherical surface data]

| | first surface | second surface | fifth surface | Sixth surface |
|---|---|---|---|---|
| K | 0 | 0 | 0 | −1.0 |
| A3 | 0 | 0 | 0 | 0.8337 |
| A4 | 1.061 | 4.672 | −0.8092 | −5.238 |
| A5 | 0 | 0 | 0 | 7.808 |
| A6 | −1.519 | 13.65 | 13.92 | 0 |
| A7 | 0 | 0 | 0 | 0 |
| A8 | 1.433 | 0 | 0 | 0 |
| A9 | 0 | 0 | 0 | 0 |
| A10 | −0.5474 | 0 | 0 | 0 |

wavelength: 850 nm
field-of-view angle: 119.9°
F-number: 2.65
sensor diagonal size: 1.99 mm

In this example, as shown in Table 4, the field-of-view angle is 90 degrees or more, and the conditions (1) through (8) are satisfied.

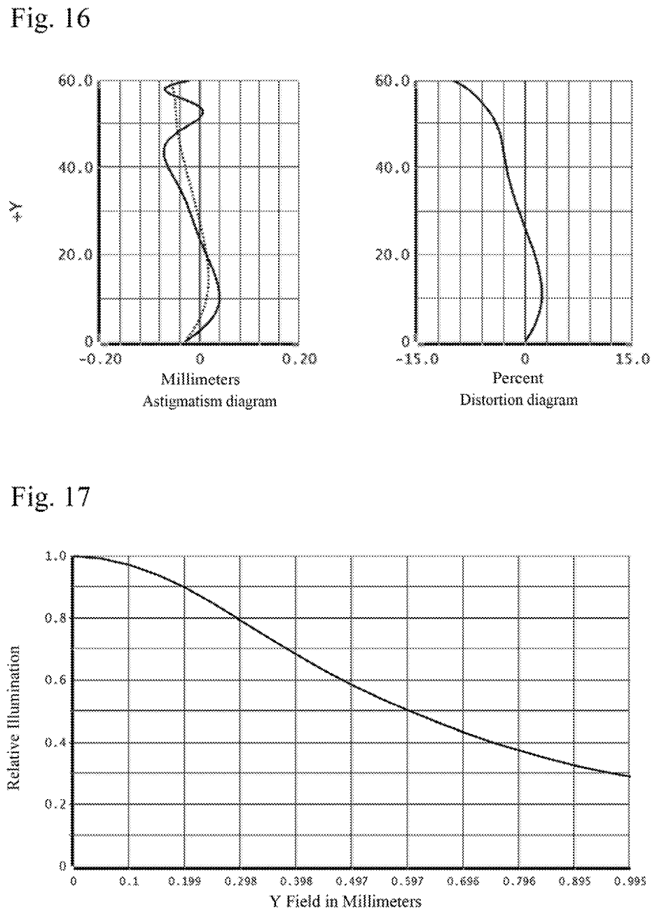

By configuring as described above, field curvature and astigmatism are sufficiently corrected as shown in FIG. 16, and a gradual peripheral light intensity change that can be corrected by the image sensor S is obtained as shown in FIG. 17. Furthermore, by bonding the filter OF and the cover glass CG via the adhesive A, a compact camera module CM with good image quality, high strength, and a wide field-of-view angle can be achieved.

It goes without saying that the present invention is not limited to the above-described examples. As is obvious to those skilled in the art:
appropriately changing combinations of mutually replaceable members and configurations disclosed in the above examples and applying them;
appropriately replacing with members and configurations that are not disclosed in the above examples but are known technologies and are mutually replaceable with the members and configurations disclosed in the above examples, and changing combinations thereof and applying them; and
appropriately replacing with members and configurations that are not disclosed in the above examples but that a person skilled in the art would contemplate as substitutes for the members and configurations disclosed in the above examples based on known technologies and the like, and changing combinations thereof and applying them;
are disclosed as embodiments of the present invention.

### DESCRIPTION OF THE REFERENCE NUMERALS

S: image sensor; L1: first lens; L2: second lens; AP: aperture stop; OF: filter; CG: cover glass; L1R1: object-side surface of first lens; L1R2: image-side surface of first lens; L2R1: object-side surface of second lens; L2R2: image-side surface of second lens; r1: radius of curvature of object-side surface of first lens; r2: radius of curvature of image-side surface of first lens; r3: radius of curvature of object-side surface of second lens; r4: radius of curvature of image-side surface of second lens; d1: distance on optical axis from object-side surface of first lens to aperture stop; d2: distance on optical axis from aperture stop to image sensor; H0: origin position on optical axis of center of object-side surface of first lens; H1: position on optical axis of object-side surface of first lens; Dc: radial inflection point position of object-side surface of first lens; D1: radial effective diameter position of object-side surface of first lens; f1: focal length of first lens; f2: focal length of second lens; NOF: refractive index of filter; NA: refractive index of adhesive; NCG: refractive index of cover glass; Y: diagonal length of light-receiving portion of image sensor; LU: lens unit; CM: camera module; LH: light-shielding component

1. A camera module in which a first lens having negative refractive power, an aperture stop configured to determine a brightness and a field-of-view angle, a second lens having positive refractive power, a filter configured to reflect or absorb a specific light, a cover glass configured to protect an image sensor, and the image sensor configured to convert a light into an electrical signal are arranged in this order from an object side toward an image side, wherein
an object-side surface of the first lens has a rotationally symmetric aspherical shape having an inflection point such that a region near an optical axis has a concave surface facing the object side and a peripheral portion has a convex surface facing the object side,
an image-side surface of the first lens has a rotationally symmetric aspherical shape having a concave surface facing the image side,
an object-side surface of the second lens has a rotationally symmetric aspherical shape having a convex surface facing the object side,
an image-side surface of the second lens has a rotationally symmetric aspherical shape having a convex surface facing the image side;
the first lens and the second lens are formed of resin;
an effective diameter of the first lens and the second lens through which a light ray passes is the largest on the object-side surface of the first lens,
the effective diameter through which the light ray passes on the object-side surface of the first lens is smaller than a diagonal length of a light-receiving portion of the image sensor, and
the camera module is configured to satisfy the following conditions (1) through (3) and has the field-of-view angle of 90 degrees or more:
$$0.1 < \vert r 2 / r 1 \vert < 0.4 \qquad ( 1 )$$
$$0.05 < \vert r 4 / r 3 \vert < 0.3 \qquad ( 2 )$$
$$1.5 < d 2 / d 1 < 3. , \qquad ( 3 )$$
wherein
r1: a radius of curvature of the object-side surface of the first lens,
r2: a radius of curvature of the image-side surface of the first lens,
r3: a radius of curvature of the object-side surface of the second lens,
r4: a radius of curvature of the image-side surface of the second lens,
d1: a distance on the optical axis from the object-side surface of the first lens to the aperture stop, and
d2: a distance on the optical axis from the aperture stop to a photosensitive surface of the image sensor.

2. The camera module according to claim 1, wherein
the following conditions (4) and (5) are satisfied, where an optical axis center position of the object-side surface of the first lens is defined as an origin, and a direction from the object side toward the image side is defined as a positive direction of the optical axis:
$$H 1 > 0 \qquad ( 4 )$$
$$0.3 < Dc / D 1 < 0.45 , \qquad ( 5 )$$
wherein
H1: a position on the optical axis of the object-side surface of the first lens,
Dc: a radial inflection point position of the object-side surface of the first lens, and
D1: a radial effective diameter position of the object-side surface of the first lens.

3. The camera module according to claim 1, wherein
the following condition (6) is satisfied:
$$0.55 < \vert f 2 / f 1 \vert < 0.85 , \qquad ( 6 )$$
f1: a focal length of the first lens, and
f2: a focal length of the second lens.

4. The camera module according to claim 1, wherein
the filter and the cover glass are bonded with a transparent adhesive and the following conditions (7) and (8) are satisfied:
$$\vert NOF - NA \vert < 0.05 \qquad ( 7 )$$
$$\vert NCG - NA \vert < 0.05 , \qquad ( 8 )$$
wherein
NOF: a refractive index of filter,
NA: a refractive index of adhesive, and
NCG: a refractive index of cover glass.
